(19) United States
(12) Patent Application Publication
(10) Pub. No.: US 2025/0384500 A1
(43) Pub. Date: Dec. 18, 2025

(54) SYSTEM OF LICENSING VIRTUAL AVATAR INTERACTION IN METAVERSE DIGITAL WAX MUSEUM AND METHOD THEREOF

(71) Applicants: SQ Technology (Shanghai) Corporation, Shanghal (CN); Inventec Corporation, Taipei (TW)

(72) Inventor: Chuan-Cheng JUNG CHIU, Shanghal (CN)

(73) Assignees: SQ Technology (Shanghai) Corporation, Shanghal (CN); Inventec Corporation, Taipei (TW)

(21) Appl. No.: 18/822,234

(22) Filed: Sep. 1, 2024

(30) Foreign Application Priority Data
Jun. 17, 2024 (CN) 202410783855.X

(51) Int. Cl. G06Q 50/18; G06F 3/14; G06T 13/40; G06T 15/00; G06T 19/00

(52) U.S. Cl. CPC G06Q 50/184; G06F 3/14; G06T 13/40; G06T 15/00; G06T 19/00

(57) ABSTRACT

A system of licensing virtual avatar interaction in metaverse digital wax museum and a method thereof are disclosed. In the system, a display device displays a virtual reality, a server serves as a node of a blockchain network, the display device is connected to the server. The server receives an assigned celebrity, a consumer's facial feature and an interaction level to generate a virtual celebrity avatar and a virtual consumer avatar, which are inputted into a trained generative AI model to output a group photo image. The server is permitted to dynamically adjust an interaction between the virtual avatars based on the interaction level, generate a non-fungible token (NFT) embedded into a license message of the assigned celebrity, and display the NFT on the digital wax museum platform for transaction. Therefore, the technical effect of improving the fun and value of the virtual avatars can be achieved.

### BACKGROUND OF THE INVENTION

### 1. Field of the Invention

The present invention relates to an interaction system and a method thereof, and more particularly to a system of licensing virtual avatar interaction in a metaverse digital wax museum and a method thereof.

### 2. Description of the Related Art

In recent years, with the vigorous development of the metaverse, various metaverse applications have sprung up. For example, a consumer can operate a virtual avatar thereof to move, browse, or play games in virtual reality.

Generally, the conventional metaverse can provide basic virtual interaction. However, simply providing this basic virtual interaction is gradually unable to meet the ever-changing needs of consumer. In view of this, some manufacturers have proposed more free technical means which allows a consumer to replace the virtual avatar's clothing, accessories, and scenes to make the consumer feel fresh and interesting. However, the conventional method is not a long-term solution, and as time goes by, the consumer becomes bored easily, so there is a problem that the virtual avatar is not interesting and valuable.

According to above-mentioned contents, what is needed is to develop a solution to solve the problem of insufficient interest and value of virtual avatar.

### SUMMARY OF THE INVENTION

An objective of the present invention is to disclose a system of licensing virtual avatar interaction in a metaverse digital wax museum and a method thereof.

To achieve the objective, the present invention discloses a system of licensing virtual avatar interaction in a metaverse digital wax museum, and the system includes a display device and a server. The display device is configured to display a virtual reality. The server is configured to serve as one of nodes of a blockchain network, and connected to the display device, wherein the server includes a non-transitory computer-readable storage medium and a hardware processor. The non-transitory computer-readable storage medium is configured to store computer readable instructions. The hardware processor is electrically connected to the non-transitory computer-readable storage medium and configured to execute the computer readable instructions to make the hardware processor execute: receiving an assigned celebrity, a consumer's facial feature, and an interaction level; generating a virtual celebrity avatar and a virtual consumer avatar to be displayed in the virtual reality based on the assigned celebrity and the consumer's facial feature; inputting the virtual celebrity avatar and the virtual consumer avatar to a generative AI model which is completely trained in advance, to make the generative AI model output a group photo image; converting the interaction level into at least one prompt to dynamically adjust at least one of expressions, clothing, accessories, action postures of the virtual celebrity avatar and the virtual consumer avatar and environment background in the group photo image; generating a non-fungible token (NFT) based on the adjusted group photo image, embedding a license message of the assigned celebrity into the NFT, displaying the NFT on a digital wax museum platform, and permitting a transaction of the non-fungible token (NFT) displayed on the digital wax museum platform through the blockchain network.

To achieve the objective, the present invention discloses a method of licensing virtual avatar interaction in metaverse digital wax museum, and the method includes steps of: connecting a display device to a server, wherein the display device is configured to display a virtual reality and the server is served as one of nodes of a blockchain network; receiving an assigned celebrity, a consumer's facial feature and an interaction level, by the server; generating a virtual celebrity avatar and a virtual consumer avatar to be displayed in the virtual reality based on the assigned celebrity and the consumer's facial feature, by the server; inputting the virtual celebrity avatar and the virtual consumer avatar to a generative AI model completely trained in advance, and receiving a group photo image outputted from the generative AI model, by the server; converting the received interaction level into the at least one prompt to dynamically adjust at least one of expressions, clothing, accessories, and action postures of the virtual celebrity avatar and the virtual consumer avatar and environment background in the group photo image, by the server; generating a non-fungible token (NFT) based on the adjusted group photo image, and embedding a license message of the assigned celebrity into the non-fungible token (NFT), displaying the NFT on a digital wax museum platform, and permitting a transaction of the non-fungible token (NFT) displayed on the digital wax museum platform through the blockchain network, by the server.

According to the above-mentioned system and method of the present invention, the difference between conventional technology and the present invention is that, in the present invention, the display device can display the virtual reality, the server can serve as a node of the blockchain network, the display device can be connected to the server; the server receives the assigned celebrity, the consumer's facial feature and the interaction level to generate the virtual celebrity avatar and the virtual consumer avatar, which are inputted into a trained generative AI model to output the group photo image; the server is permitted to dynamically adjust the interaction between the virtual avatars based on the interaction level, generate the non-fungible token (NFT) embedded into the license message of the assigned celebrity, and display the NFT on the digital wax museum platform for transaction.

Therefore, with the above-mentioned solution, the present invention can achieve the technical effect of improving the fun and value of the virtual avatars.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a system of licensing virtual avatar interaction in a metaverse digital wax museum, according to the present invention.

FIG. 2A and FIG. 2B are flowcharts of a method of licensing virtual avatar interaction in a metaverse digital wax museum, according to the present invention.

FIG. 3 is a schematic view of modules of a digital wax museum platform, according to the present invention.

FIG. 4 is a schematic view of an operation of dynamically adjusting a virtual avatar of in a group photo image by a prompt, according to an application of the present invention.

FIG. 5 is a schematic view of a non-fungible token (NFT) generated based on a group photo image, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

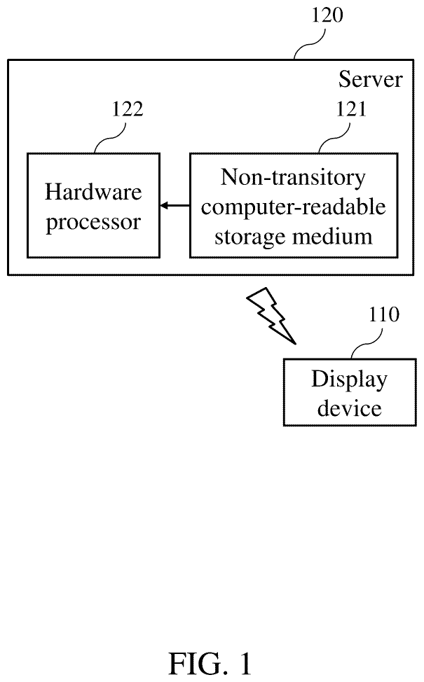

Please refer to FIG. 1. FIG. 1 is a system block diagram of a system of licensing virtual avatar interaction in metaverse digital wax museum, according to the present invention. The system includes a display device 110 and a server 120. The display device 110 is configured to display virtual reality. In actual implementation, the display device 110 can include sensors configured to sense a consumer's facial feature, transmit the consumer's facial feature to the server 120. The sensors include at least one of a laser sensor, an infrared sensor, and an image sensor. In actual implementation, the display device 110 can be implemented by a head-mounted display (HMD) device, a naked eye 3D display device or the like; however, the type of the display device 110 in the present invention is not limited, and any 3D display device can be used in the application field of the present invention.

The server 120 is configured to serve as one of nodes of a blockchain network and connected to the display device 110. The server 120 includes a non-transitory computer-readable storage medium 121 and a hardware processor 122. The non-transitory computer-readable storage medium 121 is configured to store computer readable instructions. In actual implementation, the non-transitory computer-readable storage medium 121 may include a hard disk, an optical disk, a flash memory, or the like. The computer readable instructions can be executed by the server 120. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages. In actual implementation, the server 120 can be a rack server a tower server, a cloud server, a cluster server, or the like.

The hardware processor 122 is electrically connected to the non-transitory computer-readable storage medium 121 and configured to execute the computer readable instruction, make the hardware processor 122 execute the following operations. The hardware processor 122 can receive an assigned celebrity, a consumer's facial feature and an interaction level, generate a virtual celebrity avatar and a virtual consumer avatar to be displayed in the virtual reality based on the assigned celebrity and the consumer's facial feature, input the virtual celebrity avatar and the virtual consumer avatar to a generative AI model which is completely trained in advance, receive a group photo image outputted from the generative AI model, convert the interaction level into a prompt, dynamically adjust expressions, clothing, and accessories of the virtual celebrity avatar and the virtual consumer avatar, at least one of action posture and environment background in the group photo image, generate a non-fungible token (NFT) based on the adjusted group photo image, embed a license message of the assigned celebrity into the non-fungible token (NFT), display the non-fungible token (NFT) on a digital wax museum platform, and permit a transaction of the non-fungible token (NFT) displayed on the digital wax museum platform through the blockchain network. In actual implementation, the interaction level can include levels and actions corresponding to the levels, the actions can include at least one of hand movement, facial movement and body movement with different intimacies, and the interaction level is positively correlated with the intimacy of the action, for example, a higher interaction level corresponds to a higher intimacy, and a lower interaction level corresponds to a lower intimacy. When the intimacy becomes higher, the more intimate posture is allowed during interaction, vice versa. The corresponding actions can be, based on the intimacy in an order from low to high, holding hands, hugging, and kissing. When the license message does not exist, the server 120 generates a virtual input box displayed in the virtual reality to prompt the consumer to input a password message and then transmits the password message to the digital wax museum platform for verification. When the verification is passed, the digital wax museum platform transmits the license message to the server 120; when the verification is not passed, the server 120 destroys the generated non-fungible token (NFT), for example, the non-fungible token (NFT) is transmitted to an eater address (also called blackhole address) for destroy; It is to further explain that the generative AI model can be trained with group photos of the assigned celebrity in various different poses, images of the assigned celebrity with various expressions, images of the assigned celebrity wearing various clothing and accessories, and film-and-TV photographs. Therefore, in the group photo image outputted from the generative AI model trained in advance, the virtual celebrity avatar and the virtual consumer avatar can have posture, action, expression, wearing and accessory similar to or consistent with the training data.

It is to be particularly noted that, in actual implementation, the present invention can be implemented fully or partly based on hardware, for example, one or more module of the system can be implemented by hardware processor such as integrated circuit chip, system on chip (SOC), a complex programmable logic device (CPLD), or a field programmable gate array (FPGA). The non-transitory computer-readable storage medium records computer readable instructions, and the processor can execute the computer readable instructions to implement concepts of the present invention. The non-transitory computer-readable storage medium can be a tangible apparatus for holding and storing the instructions executable of an instruction executing apparatus. The non-transitory computer-readable storage medium can be, but not limited to, electronic storage apparatus, magnetic storage apparatus, optical storage apparatus, electromagnetic storage apparatus, semiconductor storage apparatus, or any appropriate combination thereof. More particularly, the non-transitory computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable instruction can be downloaded from the non-transitory computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub, and/or gateway. The network card or network interface of each calculating/processing apparatus can receive the computer readable instructions from network and forward the computer readable instruction to store in non-transitory computer-readable storage medium of each calculating/processing apparatus.

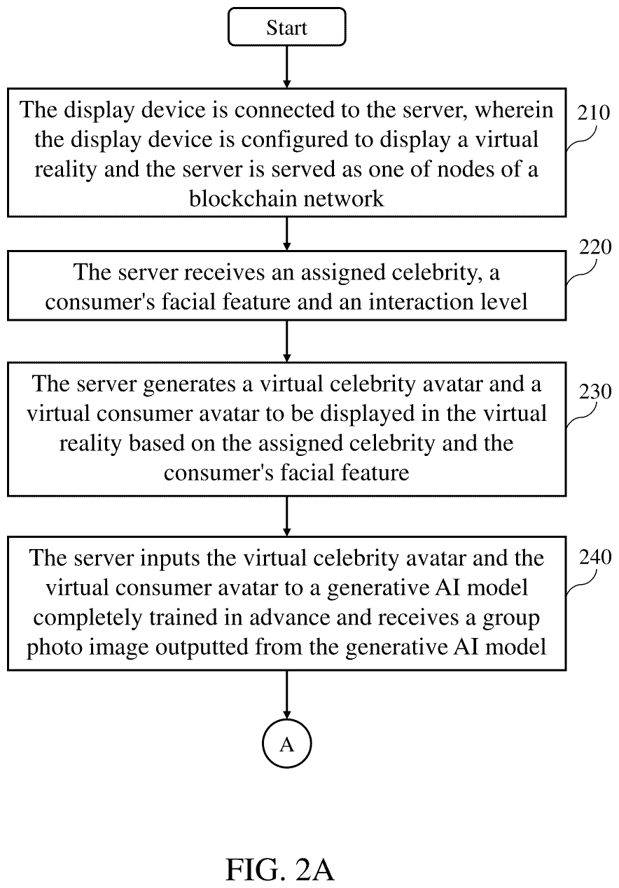

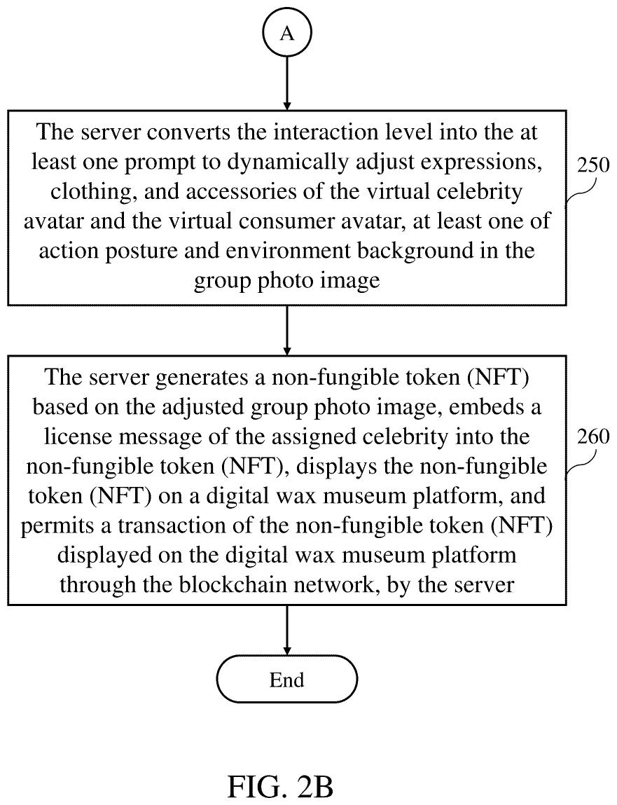

Please refer to FIG. 2A and FIG. 2B. FIG. 2A and FIG. 2B are flowcharts of a method of licensing virtual avatar interaction in metaverse digital wax museum, according to the present invention. The method includes the following steps. In a step 210, a display device 110 is connected to a server 120, wherein the display device 110 is configured to display a virtual reality and the server 120 is served as one of nodes of a blockchain network. In a step 220, the server 120 receives an assigned celebrity, a consumer's facial feature and an interaction level. In a step 230, a server 120 generates a virtual celebrity avatar and a virtual consumer avatar to be displayed in the virtual reality based on the assigned celebrity and the consumer's facial feature. In a step 240, the server 120 inputs the virtual celebrity avatar and the virtual consumer avatar to a generative AI model completely trained in advance, and receives a group photo image outputted from the generative AI model. In a step 250, the server 120 converts the interaction level into the at least one prompt to dynamically adjust expressions, clothing, and accessories of the virtual celebrity avatar and the virtual consumer avatar, at least one of action posture and environment background in the group photo image. In a step 260, the server 120 generates a non-fungible token (NFT) based on the adjusted group photo image, embeds a license message of the assigned celebrity into the non-fungible token (NFT), displays the non-fungible token (NFT) on a digital wax museum platform, and permits a transaction of the non-fungible token (NFT) displayed on the digital wax museum platform through the blockchain network. Through aforementioned steps, the display device can display the virtual reality, the server can serve as a node of the blockchain network, the display device can be connected to the server; the server receives the assigned celebrity, the consumer's facial feature and the interaction level to generate the virtual celebrity avatar and the virtual consumer avatar, which are inputted into a trained generative AI model to output the group photo image; the server is permitted to dynamically adjust the interaction between the virtual avatars based on the interaction level, generate the non-fungible token (NFT) embedded into the license message of the assigned celebrity, and display the NFT on the digital wax museum platform for transaction.

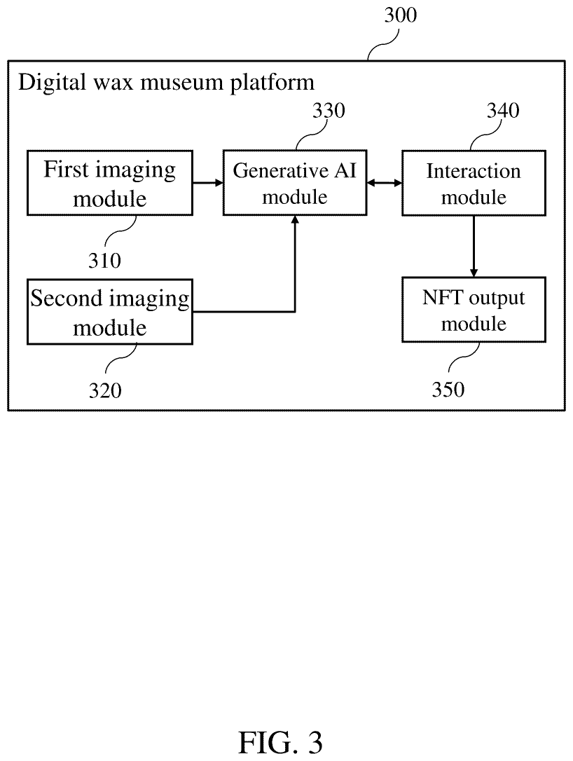

An embodiment of the present invention will be illustrated with reference to FIG. 3 to FIG. 5 in the following paragraphs. Please refer to FIG. 3. FIG. 3 is a schematic view of system modules of a digital wax museum platform, according to the present invention. In actual implementation, the digital wax museum platform is executed on the server 120, such as a digital wax museum platform 300 shown in FIG. 3. The digital wax museum platform 300 includes a first imaging module 310, a second imaging module 320, a generative AI module 330, an interaction module 340, and a NFT output module 350. The first imaging module 310 generates a virtual celebrity avatar based on pre-stored celebrity data (such as a picture or a 3D model) through virtual-imaging technology. For example, the virtual-imaging technology can include virtual reality technology, augmented reality technology, mixed reality technology, and stereoscopic imaging technology. The second imaging module 320 generates the virtual consumer avatar based on the consumer's facial feature through the virtual-imaging technology. In an embodiment, the consumer's facial feature can be obtained through an infrared sense, a depth sensor, a structured light sensor, or a camera component. The generative AI module 330 is connected to the first imaging module 310 and the second imaging module 320. The generative AI module 330 inputs the virtual celebrity avatar and the virtual consumer avatar to the trained generative AI model to generate a group photo image. The interaction module 340 is connected to the generative AI module 330 and configured to adjust the group photo image outputted from the generative AI model through a prompt. The NFT output module 350 is connected to the interaction module 340, and after the group photo image is adjusted, the NFT output module 350 generates the non-fungible token (NFT) embedded with the celebrity license message for transaction, based on the adjusted group photo image through the NFT generation process of blockchain technology. Particularly, the above-mentioned modules are differentiated by functions thereof, and the functions are implemented by different computer readable instructions, and the hardware processor to execute the computer readable instructions.

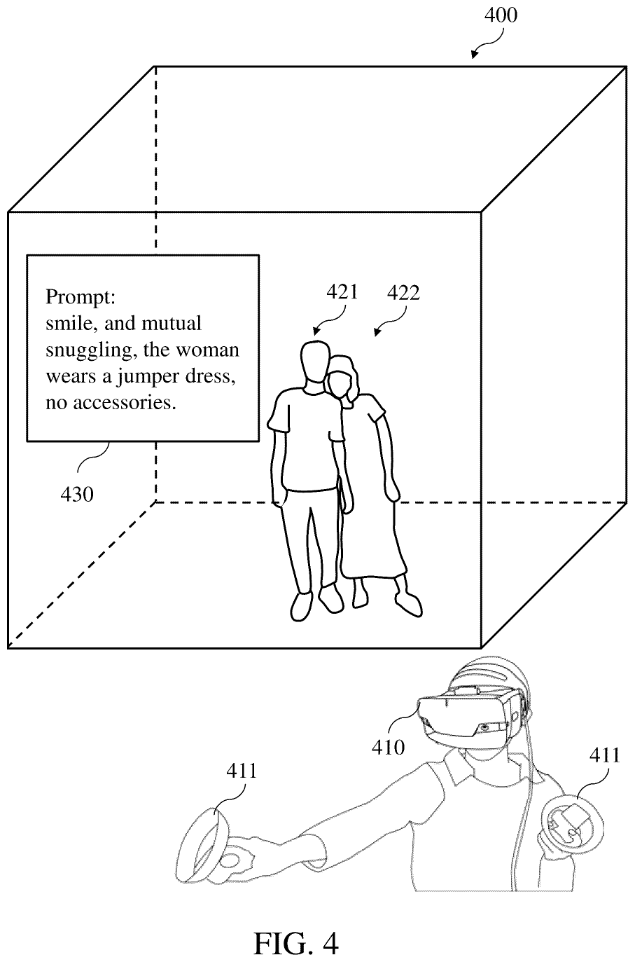

Please refer to FIG. 4. FIG. 4 is a schematic view of an operation of dynamically adjusting a virtual avatar of in a group photo image by prompt, according to an application of the present invention. When a consumer wears the display device 410, the consumer can browse a virtual reality 400, so that the consumer can use a controller 411 to select the assigned celebrity on an operation interface in the virtual reality 400 (for example, the consumer can select the assigned celebrity through a pull-down menu, or directly input a real name or a stage name of the assigned celebrity), and select the consumer's facial feature and the interaction level (for example, the consumer can select the interaction level as “intimacy”). The selection result is transmitted to the server 120, so that the server 120 generates the virtual celebrity avatar 421 and the virtual consumer avatar 422 to be displayed in the virtual reality 400. In actual implementation, the virtual celebrity avatar 421 is generated based on the celebrity data (such as a body shape or a picture), which is pre-stored and licensed, through 2D or 3D imaging technology. The virtual consumer avatar 422 is generated based on the consumer's facial feature by the same manner. The virtual celebrity avatar 421 and the virtual consumer avatar 422 are inputted to a generative AI model which is completely trained in advance, to make the generative AI model output a group photo image, and a prompt generated by converting the interaction level selected by the consumer can be inputted to the generative AI model to dynamically adjust the expression, clothing, accessory of the virtual celebrity avatar 421 and the virtual consumer avatar 422, at least one of action posture and environment background in the group photo image. For example, in a condition that the interaction level is “intimacy,” the converted prompt can be “smile and mutual snuggling”. The converted prompt can be displayed on the virtual object 430 and the consumer can add a term such as “male and female smiles”, “the woman wears a jumper dress”, “no accessories”, so that the group photo image outputted from the generative AI model can be similar to the description of the prompt. After the group photo image is adjusted, the server 120 generates a non-fungible token (NFT) based on the adjusted group photo image through the smart contract and blockchain technology and embeds the license message (such as a signature, a seal, or a certificate) of the assigned celebrity into the NFT.

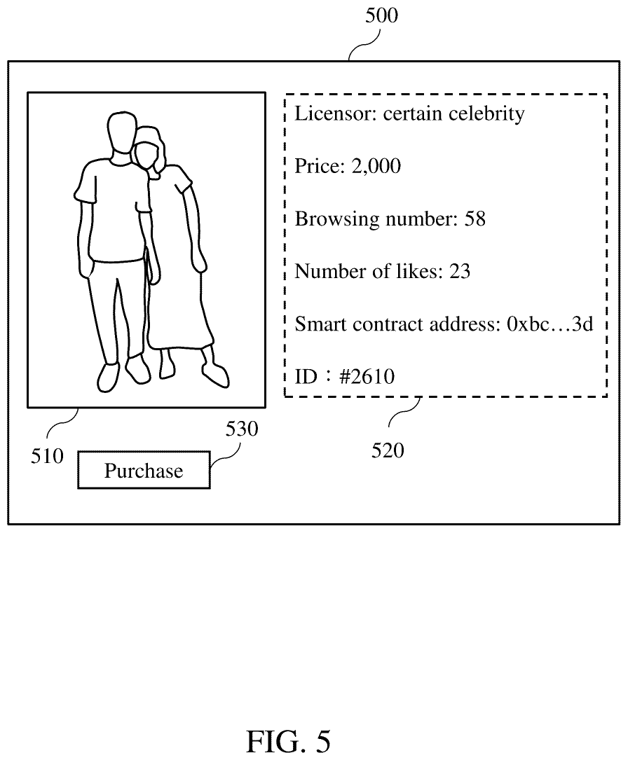

Please refer to FIG. 5. FIG. 5 is a schematic view of a non-fungible token (NFT) generated based on a group photo image, according to an application of the present invention. For example, the generated non-fungible token (NFT) can be displayed on the digital wax museum platform, such as a display space of a website or virtual reality, and a transaction of the non-fungible token (NFT) displayed on the digital wax museum platform is permitted through the blockchain network. as shown in FIG. 5, the digital wax museum platform displays a group photo image 510 in a form of the non-fungible token (NFT) on the display interface 500 and displays detailed data on the display block 520, for example, the detailed data can be information of licensor, price, browsing number, number of likes, smart contract address, or identity (ID). Another consumer can buy this NFT by clicking a purchasing component 530. The generated NFT is unique, so it is scarce, and the blockchain technology also ensures the authenticity and non-tamperability of an ownership of the NFT, and the NFT is licensed by the celebrity. Therefore, in addition to the fun in the process of generating NFT, the generated NFT also has high value.

According to above-mentioned contents, the difference between the present invention and the conventional technology is that, in the present invention, the display device can display the virtual reality, the server can serve as a node of the blockchain network, the display device can be connected to the server; the server receives the assigned celebrity, the consumer's facial feature and the interaction level to generate the virtual celebrity avatar and the virtual consumer avatar, which are inputted into a trained generative AI model to output the group photo image; the server is permitted to dynamically adjust the interaction between the virtual avatars based on the interaction level, generate the non-fungible token (NFT) embedded into the license message of the assigned celebrity, and display the NFT on the digital wax museum platform for transaction. Therefore, with the above-mentioned solution, the present invention can solve the conventional problem and achieve the technical effect of improving the fun and value of the virtual avatars.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system of licensing virtual avatar interaction in metaverse digital wax museum, comprising:
a display device, configured to display a virtual reality; and
a server, configured to serve as one of nodes of a blockchain network, and connected to the display device, wherein the server comprises:
a non-transitory computer-readable storage medium, configured to store computer readable instructions; and
a hardware processor, electrically connected to the non-transitory computer-readable storage medium and configured to execute the computer readable instructions to make the hardware processor execute:
receiving an assigned celebrity, a consumer's facial feature, and an interaction level;
generating a virtual celebrity avatar and a virtual consumer avatar to be displayed in the virtual reality based on the assigned celebrity and the consumer's facial feature;
inputting the virtual celebrity avatar and the virtual consumer avatar to a generative AI model which is completely trained in advance, to make the generative AI model output a group photo image;
converting the interaction level into at least one prompt to dynamically adjust at least one of expressions, clothing, accessories, action postures of the virtual celebrity avatar and the virtual consumer avatar and environment background in the group photo image; and
generating a non-fungible token (NFT) based on the adjusted group photo image, embedding a license message of the assigned celebrity into the NFT, displaying the NFT on a digital wax museum platform, and permitting a transaction of the NFT displayed on the digital wax museum platform through the blockchain network.

2. The system of licensing virtual avatar interaction in metaverse digital wax museum according to claim 1, wherein the interaction level comprises levels and at least one action corresponding to the levels, the at least one action comprises at least one of hand movement, facial movement and body movement with different intimacies, and each of the levels is positively correlated with the intimacy of the action.

3. The system of licensing virtual avatar interaction in metaverse digital wax museum according to claim 1, wherein when the license message does not exist, the server generates a virtual input box displayed in the virtual reality to prompt a consumer to input a password message, and transmits the password message to the digital wax museum platform for verification, wherein when the verification is passed, the digital wax museum platform transmits the license message to the server, and when the verification is not passed, the server destroys the generated NFT.

4. The system of licensing virtual avatar interaction in metaverse digital wax museum according to claim 1, wherein the display device comprises sensors configured to sense the consumer's facial feature and transmit the consumer's facial feature to the server, wherein the sensor comprises at least one of a laser sensor, an infrared sensor, and an image sensor.

5. The system of licensing virtual avatar interaction in metaverse digital wax museum according to claim 1, wherein the generative AI model uses images of the assigned celebrity in various poses and various expressions, images of the assigned celebrity wearing various clothing and accessories, and film-and-TV photographs as training data and performs training based on the training data.

6. A method of licensing virtual avatar interaction in metaverse digital wax museum, comprising:
connecting a display device to a server, wherein the display device is configured to display a virtual reality and the server is served as one of nodes of a blockchain network;
receiving an assigned celebrity, a consumer's facial feature and an interaction level, by the server;
generating a virtual celebrity avatar and a virtual consumer avatar to be displayed in the virtual reality based on the assigned celebrity and the consumer's facial feature, by the server;
inputting the virtual celebrity avatar and the virtual consumer avatar to a generative AI model completely trained in advance, and receiving a group photo image outputted from the generative AI model, by the server;
converting the received interaction level into the at least one prompt to dynamically adjust at least one of expressions, clothing, accessories, and action postures of the virtual celebrity avatar and the virtual consumer avatar and environment background in the group photo image, by the server; and
generating a non-fungible token (NFT) based on the adjusted group photo image, embedding a license message of the assigned celebrity into the NFT, displaying the NFT on a digital wax museum platform, and permitting a transaction of the NFT displayed on the digital wax museum platform through the blockchain network, by the server.

7. The method of licensing virtual avatar interaction in metaverse digital wax museum according to claim 6, wherein the interaction level comprises levels and at least one action corresponding to the levels, and the at least one action comprise at least one of hand movement, facial movement, and body movement with different intimacies, and each of the levels is positively correlated with the intimacy of the action.

8. The method of licensing virtual avatar interaction in metaverse digital wax museum according to claim 6, wherein when the license message does not exist, the server generates a virtual input box displayed in the virtual reality to prompt a consumer to input a password message, and transmits the password message to the digital wax museum platform for verification, wherein when the verification is passed, the digital wax museum platform transmits the license message to the server, wherein when the verification is not passed, the server destroys the generated NFT.

9. The method of licensing virtual avatar interaction in metaverse digital wax museum according to claim 6, wherein the display device comprises sensors configured to sense the consumer's facial feature, transmit the consumer's facial feature to the server, wherein the sensor comprises at least one of a laser sensor, an infrared sensor and an image sensor.

10. The method of licensing virtual avatar interaction in metaverse digital wax museum according to claim 6, wherein the generative AI model uses images of the assigned celebrity in various poses and various expression, images of the assigned celebrity wearing various clothing and accessories, and film-and-TV photographs as training data and uses the training data to perform training.
